(19) United States
(12) Patent Application Publication
(10) Pub. No.: US 2014/0357786 A1
(43) Pub. Date: Dec. 4, 2014

(54) Diluent Product Comprising a Bis-Oxazolidine, a Catalyst and a Polyisocyanate, and Uses Thereof

(71) Applicant: Soprema, Strasbourg (FR)

(72) Inventors: Louis Durot, Paris (FR); Pierre-Etienne Bindschedler, Obernai (FR); Virginie Francois Barseghian, Paris (FR); Remi Perrin, Boersch (FR)

(73) Assignee: SOPREMA, Strasbourg (FR)

(21) Appl. No.: 14/352,033

(22) PCT Filed: Oct. 18, 2012
(86) PCT No.: PCT/FR2012/052376

§ 371 Date: Apr. 15, 2014

(30) Foreign Application Priority Data
Oct. 20, 2011 (FR) 11 59496

(51) Int. Cl. C09D 175/04; C08J 3/00

(52) U.S. Cl. CPC C09D 175/04; C08J 3/00
USPC 524/590; 252/183.11

(57) ABSTRACT

The invention relates to a diluent comprising: a polyisocyanate having a number of isocyanate functions strictly greater than 1 and less than or equal to 3.1; a bis-oxazolidine, and a catalyst, the amounts of bis-oxazolidine and of polyisocyanate having a number of isocyanate functions strictly greater than 1 and less than or equal to 3.1 being such that the molar ratio between the —NH functions of the bis-oxazolidine and the NCO functions is from 0.3 to 0.75; the —NH functions of the bis-oxazolidine being the —NH functions derived from the amine functions formed after opening of the bis-oxazolidine ring, said diluent not comprising any solvent or any exogenous plasticizer; to polyurethane resin compositions comprising said diluent and to the uses thereof.

### FIELD OF APPLICATION

The present invention relates to a diluent intended to be introduced in polyurethane resin compositions, especially in one-component polyurethane resin compositions. Thus incorporated, this diluent can improve the properties of the composition, especially the fluidity, while at the same time allowing a good hardening rate. Polyurethane resins are very useful in many fields, in particular in public works or construction works, where they make it possible to form coatings applied onto structures, especially to provide waterproofness or protection thereto.

Conventionally, a one-component polyurethane resin composition comprises a prepolymer, which is the reaction product of a polyisocyanate with a polyol, a solvent and/or diluent, a catalyst for enabling the polymerization and optionally a compatibilizer, a filler and/or a plasticizer. The compatibilizer is necessarily present when the resin is a polyurethane resin with natural or synthetic bitumen or is intended to be applied onto a bituminous coating or onto masonry.

Polyurethane compositions may be supplemented with hardeners in order to accelerate the polymerization of the composition in the open air. A hardener that is particularly appreciated is a bis-oxazolidine. Indeed, bis-oxazolidine has certain advantages besides the acceleration of polymerization by crosslinking. As such, the use of bis-oxazolidine aids in reducing the formation of foam that is inherent in latent open-air polymerization of polyurethane resins. Indeed, during polymerization without this type of hardener, the isocyanate functions of the prepolymers react together in the presence of atmospheric moisture to form urea bonds, releasing carbon dioxide. The released gas leads to the formation of foam which generates surface defects on the final coating. The use of bis-oxazolidine allows another mode of polymerization which does not generate any carbon dioxide. The bis-oxazolidine reacts with atmospheric moisture, which leads to the opening of the two bis-oxazolidine rings. The open bis-oxazolidine comprises —OH and —NH functions which can react with the isocyanate functions of the prepolymers. Thus, the system polymerizes by formation of urethane and urea bonds without generating carbon dioxide. Furthermore, certain bis-oxazolidines have the additional advantage of being diluents, which would theoretically make it possible to lower the viscosity of the composition and to improve the compatibilization between the prepolymer and the bitumen. However, this diluent and compatibilizing effect cannot be obtained with the working amounts recommended by the manufacturers since they are too low.

The addition of bis-oxazolidine in amounts higher than the recommended amounts leads to a coating that shows instabilities and that presents risks of under-polymerization. Indeed, the bis-oxazolidine used should not be too reactive or too unreactive to prevent the composition from polymerizing on storage. If too much unreactive bis-oxazolidine is used, some rings of the bis-oxazolidine will not open quickly enough to react with the isocyanate functions of the prepolymers. The rings that have not opened during the open-air polymerization will open once the coating has been formed, under the action of the air moisture, which will generate free —OH and —NH functions in the final coating. This coating will be sensitive to water uptake, which will give rise to swelling and to lifting of the coating and under-polymerization.

The present inventors have found that it is possible to use a large amount of bis-oxazolidine, optionally with a mono-oxazolidine, to lower the viscosity of the composition and avoid the formation of foam during polymerization, without deteriorating the mechanical characteristics of the coating obtained. To do this, they have found that it is necessary to use, together with the bis-oxazolidine, a high dose of catalyst and a polyisocyanate. This novel composition with advantageous diluent properties enables the amounts of solvent in the composition to be reduced and improves the compatibilization, especially with bitumens.

Furthermore, the introduction of the diluent into a composition according to the invention makes it possible to use prepolymers with a low isocyanate content, i.e. elastomeric prepolymers with a NCO functionality close to 2 and thus to obtain liquid compositions which give elastomeric coatings. Indeed, a composition with a high isocyanate content is usually needed to dilute a polyurethane resin composition with bis-oxazolidine alone, otherwise the bis-oxazolidine will not polymerize completely, which will give rise to defects in the coating. To obtain a high isocyanate content in the composition, prepolymers with a high isocyanate content such as prepolymers with a functionality of close to 3 may be used. However, trifunctional prepolymers lead to rigid, nonelastomeric coatings, which is not desirable for producing waterproof coatings.

Thus, the present invention relates to a diluent comprising a polyisocyanate, a bis-oxazolidine optionally with a mono-oxazolidine, and a catalyst.

### DEFINITIONS

According to the present invention, the term “liquid composition” means a composition with a viscosity between 1,000 and 40,000 centipoises, said viscosity being measured at 23° C. using a Brookfield viscometer (for viscosities of less than 10,000 centipoises, the measurements are taken with the R5 module at a speed of 30 rpm and for viscosities of greater than 10,000 centipoises, the measurements are taken with the R6 module at a speed of 20 rpm). Such a viscosity allows the application of the composition especially with a roller commonly known as a “fabric roller” or a brush to form 0.5 to 2 mm thick layers in one or more applications.

The term “one-component composition” or “ready-to-use composition” means a composition which is intended to be applied on its own by the final user, i.e. by the worker who will produce the waterproof coating. Such a ready-to-use composition is conventionally known in the art as a “one-component” composition, as opposed to compositions which require the addition of a catalyst or hardener or other reactive agent before use or which must be applied in a limited time span (a few hours) after being mixed.

The term “stable composition” means a composition which can be stored for a minimum of 4 months without any phase separation or mass gelling being observed.

The term “traffic-bearing coating” means a coating whose mechanical strength is sufficient to allow the circulation of people and vehicles on its free surface.

The term “coating with good mechanical strength” means a coating which has a tensile strength of greater than or equal to 2 MPa for a non-traffic-bearing coating and a tensile strength of greater than or equal to 5 MPa for a traffic-bearing coating (the tensile strength is measured on an Instron machine according to standard EN ISO 527-3). Conventionally, in practice, for an elongation of greater than or equal to 100%, a non-traffic-bearing coating has a tensile strength of 2 to 3 MPa and a traffic-bearing coating has a tensile strength of 5 to 8 MPa. Higher values for a traffic-bearing coating are obviously acceptable.

The term “self-protected coating, which is resistant to UV rays, to weathering and to chemical attack” means a coating which has a degradation level of the mechanical properties of less than 50% after aging for 2,500 hours in an accelerated aging chamber in cycles alternating 6 hours of exposure to UVA and 6 hours of water condensation at 60° C.

The term “prepolymer” means a reaction product of a polyol or of a mixture of polyols containing a number of OH functions between 1.5 and 3 with a polyisocyanate or a mixture of polyisocyanates containing a number of NCO functions between 1.6 and 3, in a stoichiometric molecular ratio of from 1.5 to 2.5 approximately of polyisocyanate or of the polyisocyanate mixture relative to the polyol or mixture of polyols.

Conventionally, the polyols used are especially polyether type such as a polyethylene glycol (PEG), a polypropylene glycol (PPG), a polypropylene glycol glycerol triol, or a polytetrahydrofuran (PTHF) or polyester type polyol, such as Priplast® 3196 sold by Croda or Krasol® LBH-p 3000 sold by Cray Valley or a polycaprolactone such as PCP 1000 sold by Solvay.

The term “polyisocyanate” means a compound containing more than one isocyanate function; the diisocyanate may therefore also be termed in the present application a polyisocyanate.

The term “TDI” means toluene diisocyanate.

The term “MDI” means diphenylmethane diisocyanate.

The term “HDI” means hexamethylene diisocyanate.

The term “IPDI” means isophorone diisocyanate.

The term “solvent” means any solvent that is conventionally used in polyurethane resin compositions, said solvent being inert toward the reagents contained in the composition, liquid at room temperature and having a boiling point below 240° C.

The term “exogenous plasticizer” means a molecule or an oligomer added to the polymer resin compositions, such as a polyurethane resin composition, to make the resulting material more flexible, less resistant, more resilient and/or easier to manipulate, said exogenous plasticizer being inert, i.e. it does not comprise any reactive functions that would enable it to react with itself or with the prepolymers contained in the composition.

The term “mono-oxazolidine” means a 5-membered cyclic product which comprises only one nitrogen and at least one oxygen and which is opened in the presence of atmospheric moisture to lead to only one reactive nitrogen function.

Diluent

A first object of the invention is a diluent comprising:
a polyisocyanate or a mixture of polyisocyanates having a number of isocyanate functions strictly greater than 1 and less than or equal to 3.1, preferably greater than 1.5 and less than or equal to 2.2,
a bis-oxazolidine and optionally a mono-oxazolidine, and
a catalyst,
   the amounts of bis-oxazolidine, and optionally of mono-oxazolidine, and of polyisocyanate or of the mixture of polyisocyanates having a number of isocyanate functions strictly greater than 1 and less than or equal to 3.1 being such that the molar ratio between the —NH functions of the bis-oxazolidine, and optionally of the mono-oxazolidine, and the NCO functions is from 0.3 to 0.75; the —NH functions of the bis-oxazolidine, and optionally of the mono-oxazolidine, being the —NH functions derived from the amine functions formed after opening of the oxazolidine ring.

Preferably, said diluent does not comprise any solvent.

Preferably, said diluent does not comprise any exogenous plasticizer.

A second object of the invention is a diluent consisting of:
a polyisocyanate or a mixture of polyisocyanates having a number of isocyanate functions strictly greater than 1 and less than or equal to 3.1, preferably greater than 1.5 and less than or equal to 2.2,
a bis-oxazolidine and optionally a mono-oxazolidine, and
a catalyst,
   the amounts of bis-oxazolidine, and optionally of mono-oxazolidine, and of polyisocyanate or of the mixture of polyisocyanates having a number of isocyanate functions strictly greater than 1 and less than or equal to 3.1 being such that the molar ratio between the —NH functions of the bis-oxazolidine, and optionally of the mono-oxazolidine, and the NCO functions is from 0.3 to 0.75; the —NH functions of the bis-oxazolidine, and optionally of the mono-oxazolidine, being the —NH functions derived from the amine functions formed after opening of the oxazolidine ring.

The ratio between the bis-oxazolidine, and optionally the mono-oxazolidine, and the polyisocyanate or the mixture of polyisocyanates is such that the number of NCO functions of the polyisocyanate is greater than the number of —NH functions of the bis-oxazolidine, and optionally of the mono-oxazolidine (derived from the amine functions released after opening of the bis-oxazolidine ring), such that all the —NH functions react with the NCO functions of the polyisocyanate.

The number of isocyanate functions is estimated by calculation after NCO titration by back-titrating the excess of dibutylamine with hydrochloric acid (according to standard EN ISO 14896-2006).

The amount of mono-oxazolidine in the diluent according to the invention is between 0 and 40% by weight and preferably between 5% and 25% by weight relative to the weight of the bis-oxazolidine.

The amount of catalyst in the diluent according to the invention is between 10% and 70%, preferably between 20% and 50% and more preferentially between 30% and 50% by weight relative to the weight of the bis-oxazolidine.

According to a particular embodiment, the diluent according to the invention comprises:
an amount of polyisocyanate having a number of isocyanate functions strictly greater than 1 and less than or equal to 3.1, such that the number of NCO functions is equivalent to that of 100 parts by weight of diphenylmethane diisocyanate MDI (CAS No. 26447-40-5);
40 to 100 parts by weight of bis-oxazolidine and optionally of mono-oxazolidine,
30 to 50 parts by weight of catalyst.

The bis-oxazolidine introduced in the diluent according to the invention should not have too high a viscosity so as to have diluent properties. The term “diluent properties” means the capacity of a product to dissolve and/or lower the viscosity of the composition into which it is added. Thus, according to a particular embodiment, said bis-oxazolidine has a viscosity of less than 80 mPa·s at 20° C., preferably of the order of 50 mPa·s at 20° C., measured using a Brookfield viscometer (module 3, 20 rpm).

The bis-oxazolidine is a dioxazolane derivative. Preferably, the bis-oxazolidine comprises a carbonate group between the two oxazolidine rings and corresponds to the following general formula:

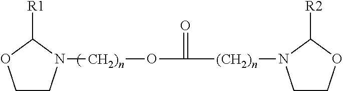

wherein n is an integer equal to 1, 2, 3 or 4; and wherein R1 and R2 are, independently, a hydrogen or a linear or branched alkyl comprising 1 to 4 carbon atoms.

According to a particular embodiment, the bis-oxazolidine is the product sold by Incorez under the brand name Incozol@ LV (CAS No. 145899-78-1) having the following general formula:

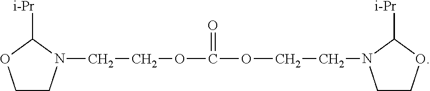

The mono-oxazolidine is a mono-oxazolidine free of OH groups. According to a particular embodiment, the mono-oxazolidine is the product sold by Angus under the brand name Zoldine® ZE (CAS No. 7747-35-5) having the following general formula:

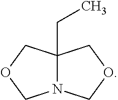

The catalyst used in the diluent according to the invention is chosen from the group comprising organic acid anhydrides, long-chain fatty acids and organometallic salts, and mixtures thereof. Preferably, the catalyst used in the diluent according to the invention is an organic acid anhydride.

Examples of organic acid anhydrides that may be used include methyltetrahydrophthalic anhydride (MHTPA), methylnadic anhydride (also known as endo-cis-bicyclo(2,2,1)-5-heptene-2,3-dicarboxylic anhydride—CAS No. 129-64-6) and methylsuccinic anhydride.

Examples of long-chain fatty acids that may be used include stearic acid, palmitic acid and oleic acid.

Examples of organometallic salts that may be used include heavy metal salts of fatty acids such as lead, barium, tin or cadmium salts of fatty acids.

According to a particular embodiment, the bis-oxazolidine sold by Incorez under the brand name Incozol® LV is used with MHTPA as catalyst.

The polyisocyanate having a number of isocyanate functions strictly greater than 1 and less than or equal to 3.1 used in the diluent according to the invention is chosen from the group comprising aromatic, aliphatic and cycloaliphatic polyisocyanates, and mixtures thereof.

Said polyisocyanate may be chosen from the group of standard polyisocyanates comprising 2,4-toluene diisocyanate (TDI), a TDI trimer, diphenyl methane diisocyanate (MDI), a polymeric MDI, hexamethylene diisocyanate (HDI), a HDI trimer, isophorone diisocyanate (IPDI), an IPDI trimer, and mixtures thereof.

More particularly, a modified MDI containing 2 isocyanate functions, such as Suprasec® 2385 sold by Huntsman, may be used.

An example of an aliphatic polyisocyanate that may be used is HDI containing 2 isocyanate functions, such as Desmodur® N3400 sold by Bayer.

Said polyisocyanate used in the diluent according to the invention may also be a prepolymer resulting from the reaction between a polyol or a mixture of polyols containing a number of OH functions between 1.5 and 3 and a polyisocyanate or a mixture of polyisocyanates containing a number of NCO functions between 1.6 and 3, in a ratio such that the number of NCO functions of the polyisocyanate or of the polyisocyanate mixture relative to the number of OH functions of the polyol or mixture of polyols is from 1.5 to 2.5 approximately. Said polyisocyanate used in the diluent according to the invention may also be a polymerizable plasticizer containing a hydrocarbon chain, only one end of which bears more than one isocyanate function, said polymerizable plasticizer being the reaction product of:
an alcohol type compound containing a hydrocarbon chain comprising and/or being substituted with an aromatic ring and/or an aliphatic ring and/or said hydrocarbon chain of the alcohol type compound is substituted with at least two hydrocarbon chains which may comprise an unsaturation and wherein said alcohol type compound has an —OH number between 0.8% and 2.5%; with
a polyisocyanate comprising 2.1 to 3.2 isocyanate functions and preferably 2.5 to 3.1 isocyanate functions;
   as described in patent application PCT/FR2012/052369 filed on Oct. 18, 2012 in the name of the Applicant, which is incorporated by reference.

According to a particular embodiment, said polymerizable plasticizer containing a hydrocarbon chain, only one end of which bears more than one isocyanate function, is the reaction product of a polymeric MDI containing 2.7 NCO functions with a phenolic coumarone resin or a phenolic α-methylstyrene resin.

Said polyisocyanate used in the diluent according to the invention may also be a polyisocyanate masked with a monoalcohol, the NCO functionality of the masked polyisocyanate being between 1.5 and 2.2, said masked polyisocyanate being the reaction product of a monoalcohol of formula B—OH with a polyisocyanate of formula A-NCO, wherein B represents an alkyl, and A represents a group comprising a number of isocyanate functions between 1.5 and 2.2, preferably between 1.5 and 2.1 and even more preferentially between 1.5 and 2. Such a masked polyisocyanate is described in application PCT/FR2012/052372 filed on 18 Oct. 2012 in the name of the Applicant, which is incorporated by reference.

According to a particular embodiment, said polyisocyanate masked with a monoalcohol whose isocyanate functionality is between 1.5 and 2.2 is the reaction product of a polymeric MDI with a C₂-C₂₀ aliphatic monoalcohol, preferably a C₃-C₁₂ and even more preferentially C₄-C₁₀ aliphatic monoalcohol.

The polyisocyanate used in the diluent according to the invention may be a mixture of standard polyisocyanate, of masked polyisocyanate, of prepolymer and/or of polymerizable plasticizer as described previously.

The diluent according to the invention should preferentially be used rapidly after its preparation so that the polyisocyanate does not react with the bis-oxazolidine. The diluent according to the invention is thus a manufacturing intermediate that is not stable after two days of storage. The diluent according to the invention should be stored protected from air and moisture. On the other hand, when the diluent is added to a polyurethane resin composition, preferably a one-component polyurethane resin composition, the resulting composition is stable and may be stored for a minimum of 4 months without any phase separation or mass gelling being observed. Indeed, the diluent according to the invention will be diluted in the mass of the composition and the polyisocyanate will not react with the bis-oxazolidine as long as the composition is not exposed to atmospheric moisture.

Polyurethane Resin Composition

Another object of the invention is a polyurethane resin composition, preferably a stable one-component polyurethane resin composition, incorporating said diluent. As a result of the low viscosity and of the diluent power of the previously described diluent, the composition may be liquid while at the same time having a much lower amount of solvent than that required in an equivalent composition not containing this diluent.

This composition may be a one-component polyurethane resin composition or alternatively part of a multi-component polyurethane resin composition, more particularly the isocyanate part of a two-component composition.

Preferably, the polyurethane resin composition according to the invention is not a polyurethane foam composition. As a result, according to a particular embodiment, the composition according to the invention will not be mixed with water to polymerize and give a polyurethane foam. Similarly, the composition according to the invention is not intended to be mixed with a blowing agent, such as a gas, for example propane, butane, isobutane, carbon dioxide, carbon monoxide or dimethyl ether to form a polyurethane foam.

One object of the invention is thus a polyurethane resin composition, preferably a stable one-component composition, and even more preferentially a solvent-free stable one-component composition, which comprises:
at least one diluent which comprises:
   at least one polyisocyanate having a number of isocyanate functions strictly greater than 1 and less than or equal to 3.1, preferably greater than 1.5 and less than or equal to 2.2;
   at least one bis-oxazolidine and optionally a mono-oxazolidine;
   at least one catalyst;
at least one prepolymer;
optionally a plasticizer;
optionally solvent and/or diluent;
optionally fillers.

By introducing the diluent according to the invention into a polyurethane resin composition not comprising any other catalyst, the amount of catalyst introduced into the resulting polyurethane resin composition is two to ten times higher than the amounts conventionally used in industry. Indeed, the dose of catalyst usually recommended, especially of organic acid anhydride, in a polyurethane resin composition is between 0.02% and 0.5% by weight relative to the weight of the composition. In the context of the invention, the bis-oxazolidine, and optionally the mono-oxazolidine, is activated by adding catalyst in an amount ranging from 0.5% to 5%, preferably from 0.5% to 3.5%, more preferentially from 0.6% to 2.5% and even more preferentially from 1% to 2.2% by weight relative to the weight of the composition.

According to an advantageous embodiment, the compositions according to the invention are liquid and have a solvent content of less than 10%, preferably less than 5% and even more preferentially less than 2%. They may even be totally free of solvent.

According to another advantageous embodiment, the compositions according to the invention are liquid and have a content of exogenous plasticizer of less than 10%, preferably less than 5% and even more preferentially less than 2%. They may even be totally free of exogenous plasticizer.

According to an advantageous embodiment, the polyurethane resin composition according to the invention comprises:
from 10% to 70%, preferably from 15% to 50% and even more preferentially from 20% to 45% by weight of diluent as defined above relative to the weight of the composition;
from 30% to 90%, preferably from 35% to 85% and even more preferentially from 45% to 80% by weight of a prepolymer relative to the weight of the composition;
from 0 to 20%, preferably from 2% to 15% and even more preferentially from 5% to 10% by weight of a filler relative to the weight of the composition;
from 0 to 10%, preferably from 0 to 5% and even more preferentially from 0 to 3% by weight of solvent relative to the weight of the composition;
from 0 to 50%, preferably from 5% to 45% and even more preferentially from 10% to 40% by weight of an exogenous plasticizer or of a polymerizable plasticizer as defined in patent application no. PCT/FR2012/052369 relative to the weight of the composition;
from 0 to 50%, preferably from 5% to 45% and even more preferentially from 10% to 40% by weight of a bituminous mixture relative to the weight of the composition,
   said composition comprising between 0.5% and 5% by weight of catalyst relative to the weight of the composition, said catalyst originating from the introduction of the diluent according to the invention into said composition, with the exclusion of any other source of catalyst.

According to a particular embodiment, the polyurethane composition according to the invention comprises an amount of bis-oxazolidine which is dosed relative to the isocyanate content of the composition, the source of isocyanate in the composition originating from a standard polyisocyanate, a masked polyisocyanate, a prepolymer and/or a polymerizable plasticizer as defined above. Thus, the amount of bis-oxazolidine in the composition is preferentially between 1 and 1.7 times the isocyanate content of the composition.

The prepolymers introduced in the composition according to the invention are commercial products, but they may also be synthesized before preparing the polyurethane resin composition. Conventionally, the prepolymers are formed by reaction between:
a polyol containing between 1.5 and 3 OH functions and having a molecular weight between 900 and 3,000 g/mol, preferably between 1,000 and 2,800 g/mol and more preferentially between 1,500 and 2,500 g/mol; and
a diisocyanate and/or polyisocyanate containing between 1.6 and 3 NCO functions;
   in a ratio such that the number of NCO functions of the polyisocyanate relative to the number of OH functions of the polyol is from 1.5 to 2.5 approximately.

The polyol used to form the prepolymer may be a polyether, polyester, polybutadiene or polycarbonate type polyol, and mixtures thereof.

The polyether type polyol may be a polypropylene glycol, a polyethylene glycol, a polypropylene glycol glycerol triol, a polyethylene glycol glycerol triol, or a polytetrahydrofuran.

The polyester type polyol may be a polycaprolactone, a polyester of fatty acid dimers comprising 34 to 36 carbon atoms, a polyadipate polyester or a polyphthalate polyester.

The polycarbonate polyol may be a 1,6-hexanediol polycarbonate.

Preferably, the polyol containing between 1.5 and 3 OH functions and having a molecular weight between 900 and 3,000 g/mol introduced in the formation of the prepolymer is a polytetrahydrofuran, a 1,6-hexanediol polycarbonate, a polyester of fatty acid dimers comprising 34 to 36 carbon atoms, a polycaprolactone or a hydroxylated polybutadiene.

The diisocyanate and/or polyisocyanate used to form the prepolymer may be MDI, a polymeric MDI, TDI, a TDI trimer, HDI, a HDI trimer, IPDI, an IPDI trimer, and mixtures thereof.

Preferably, the diisocyanate and/or polyisocyanate used to form the prepolymer is MDI, a polymeric MDI, TDI, a TDI trimer, and mixtures thereof.

The bituminous mixture, which may be used in the composition according to the invention, is a mixture known as a cut-back and comprises a natural or synthetic bitumen and optionally a plasticizing oil. The fillers that may be used in the present composition are especially pigments, pulverulent fillers such as calcium carbonate, titanium oxide or the like.

Aromatic plasticizing oils or plasticizers such as diisopropylnaphthalene, dioctyl phthalate (DOP), diisononyl phthalate (DINP), Mesamoll®, trimethylpentanediol diisobutyrate (TXIB) and butylbenzyl phthalate may be used in the composition.

Use

Another object of the invention is the use of the previously described diluent in polyurethane resin compositions, preferably in stable one-component polyurethane resin compositions. The use of the diluent according to the invention makes it possible to lower the viscosity of the composition while at the same time allowing a good hardening rate and without generating any foam.

The invention also relates to the use of the composition according to the invention for making coatings, especially waterproof coatings, which do not have any surface defects, such as bubbles, and which are strong enough for exterior use, unprotected and optionally traffic-bearing. The obtained coatings have an entirely satisfactory water uptake, i.e. less than 8% after 28 days of immersion in water at 20° C. The coatings obtained by the use of the composition according to the invention can cover horizontal, oblique, vertical or rough surfaces and/or surfaces comprising singular points.

The non-bituminous polyurethane resin compositions are preferentially used for waterproofing exterior traffic-bearing horizontal surfaces, such as balconies, stadium terraces, parking lots, building courtyards, etc.

The bituminous polyurethane resin compositions are preferentially used for making flashings, i.e. for making a waterproof coating between a bituminous surface and a vertical wall or a singular point, or for renovating roofs.

The invention will be described in greater detail with the aid of the following examples, which are given for purely illustrative purposes.

### EXAMPLES

In the examples, the parts are expressed on a weight basis. The viscosities are measured using a Brookfield viscometer, spindle 5 or 6, speed 20 rpm at 23° C., less than one week after manufacturing the product or the composition.

In the examples, the following commercial products and abbreviations are used:

Incozol® LV=bis-oxazolidine comprising a carbonate group (CAS No. 145899-78-1) sold by Incorez.

MHTPA=methyltetrahydrophthalic anhydride sold by Huntsman under the brand name Aradur® HY918.

Plastisol=PVC dispersion sold under the brand name Pevikon® P709 in a plasticizer (Ruetasolv® Di).

Hyperlast® 170/80=PTHF/TDI prepolymer sold by Dow Chemical.

Suprasec® 2385=modified MDI containing 2 isocyanate functions, sold by Huntsman.

MPA=methoxypropyl acetate.

Voranol® 2000: polypropylene glycol with a molecular weight of 2,000 g/mol sold by Dow Chemical.

Voranol® CP 450: polypropylene glycol glycerol triol with a molecular weight of 450 g/mol sold by Dow Chemical.

PolyTHF® 2000: polytetrahydrofuran containing 2 NCO functions and having a molecular weight of 2,000 g/mol sold by BASF.

Ruetasolv® Di: diisopropylnaphthalene plasticizing aromatic oil sold by Rutgers.

### Example 1

### Preparation of a Diluent According to the Invention

100 parts by weight of Suprasec® 2385, 75 parts by weight of Incozol® LV and 50 parts by weight of MHTPA are mixed at room temperature in a mixer.

The diluent obtained has a viscosity of about 150 cPs and makes it possible to improve the fluidity of one-component polyurethane resin compositions containing it, while at the same time allowing a good hardening rate.

### Example 2

### Preparation of a Diluent According to the Invention

170 parts by weight of Suprasec® 2385, 100 parts by weight of Incozol® LV and 30 parts by weight of MHTPA are mixed at room temperature in a mixer.

The diluent obtained has a viscosity of about 400 cPs and makes it possible to improve the fluidity of one-component polyurethane resin compositions containing it, while at the same time allowing a good hardening rate.

### Example 3

### Preparation of a Diluent According to the Invention

A TDI adduct is formed in a mixer by mixing 350 parts by weight of TDI and 500 parts of Ruetasolv® Di. 150 parts of dipropylene glycol are gradually added to this mixture so as to keep the temperature below 55° C.

370 parts by weight of TDI adduct synthesized above, 100 parts by weight of Incozol® LV and 30 parts by weight of MHTPA are mixed at room temperature in a mixer.

The diluent obtained has a viscosity of about 150 cPs and makes it possible to improve the fluidity of one-component polyurethane resin compositions containing it, while at the same time allowing a good hardening rate.

### Example 4

### Preparation of a Diluent According to the Invention

A masked polyisocyanate is prepared in a mixer by mixing 37 parts of Suprasec® 5025 in 32.3 parts of Ruetasolv® Di, and 12 parts of 2-ethylhexanol are gradually introduced such that the temperature remains below 50° C.

330 parts by weight of masked polyisocyanate synthesized above, 100 parts by weight of Incozol® LV and 30 parts by weight of MHTPA are mixed at room temperature in a mixer.

The diluent obtained has a viscosity of about 900 cPs and makes it possible to improve the fluidity of one-component polyurethane resin compositions containing it, while at the same time allowing a good hardening rate.

### Example 5

### Polyurethane Resin Composition (Comparative)

100 parts of PolyTHF® 2000, 31 parts of Suprasec® 2385 and 100 parts of Plastisol are placed in a reactor. The mixture is heated at 110° C. for 4 hours with stirring.

The composition obtained is diluted by weight using 20% of a solvent mixture comprising ⅔ of MPA-⅓ of methyl ethyl ketone.

This one-component polyurethane resin composition may be used for a roof coating. It has a solids content of about 80% and therefore is not compliant with all the national legislations relating to the solvent content.

This composition is thixotropic and has a viscosity of about 20,000 cPs.

### Example 6

### Polyurethane Resin Composition According to the Invention

The process is performed as in example 5, replacing 15% by weight of the solvent mixture (i.e. ¾ of the solvent) with 15% by weight of the diluent obtained in example 1.

This stable, ready-to-use composition may be used for a roof coating. It has a solids content of about 95% and is therefore compliant with all the national legislations relating to the solvent content.

This composition is thixotropic and has a viscosity of about 20,000 cPs.

### Example 7

### Polyurethane Resin Composition (Coaparative)

100 parts of Hyperlast® 170/80, 30 parts of xylene, 0.02 part of dibutyltin dilaurate and 5 parts of pigment are placed in a mixer-disperser.

A liquid composition for producing waterproof interior coatings is obtained.

### Example 8

The process is performed as in example 7, but replacing the 30 parts of xylene with 30 parts of the diluent obtained in example 1.

A solvent-free, stable, liquid, one-component polyurethane resin composition is obtained, which makes it possible to produce defect-free (no bubbling) waterproof coatings with good mechanical characteristics.

The coatings obtained using this composition have an entirely satisfactory water uptake, which is less than 8% after immersion for 28 days in a water bath at 20° C.

### Example 9

### Comparative

100 parts of Voranol® 2000, 7 parts of Voranol® CP 450, 35 parts of TDI and 15 parts of xylene are placed in a reactor. The reaction mixture is heated at 80° C. for 2 hours.

0.02 part of dibutyltin dilaurate, 1 part of carbon black and 75 parts of Ruetasolv® Di aromatic oil are then added.

A stable liquid composition for producing waterproof interior coatings is obtained.

### Example 10

The process is performed as in example 9, but replacing the 15 parts of xylene with 15 parts of the diluent obtained in example 1.

A solvent-free, stable, liquid, one-component polyurethane resin composition is obtained, which makes it possible to produce defect-free (no bubbling) waterproof coatings with good mechanical characteristics.

The coatings obtained using this composition have an entirely commercially satisfactory water uptake, which is less than 8% after immersion for 28 days in a water bath at 20° C.

### Example 11

### (Comparative)—Composition for a Base Liquid Waterproof Coat

A composition having the following formula is prepared:

| | | |
|---|---|---|
| A. | Voranol ® 2000 | 200 parts |
| B. | Voranol ® CP 450 | 18 parts |
| C. | Butanediol | 9 parts |
| D. | TDI | 72 parts |
| E. | Dehydrated filler and pulverulent pigments | 27 parts |
| | dispersed in a plasticizer, the ratio of which is 2 | |
| | fillers/1 plasticizer | |
| F. | Xylene solvent | 19 parts |

A prepolymer is prepared in a reactor by introducing constituents A to D and baking at 80° C. for 1 h 30. Next, components E and F are added to this prepolymer, once cold, with stirring. This system is quite slow-hardening, i.e. the hardening time is longer than 24 hours; it is generally not catalyzed since the catalyst would bring about an excessively rapid formation of carbon dioxide and therefore bubbling and foaming, which, for that matter, are never completely avoided.

The composition has a solids content of about 94%, i.e. about 6% solvent.

### Example 12

### Stable Liquid One-Component Composition for a Waterproof Coating

A diluent according to the invention is prepared, which comprises:

9 parts of Incozol® LV

9 parts of Suprasec® 2385

5 parts of MHTPA.

A prepolymer is prepared as in example 11, component E is added thereto, and 7 parts of xylene and 32 parts of the diluent prepared above are added.

The composition obtained differs from that of example 11 by the following 3 properties:
it hardens much more quickly and may thus be subjected to circulation and coverage the day after the application, and occasionally even the same day, which the composition of example 11 does not allow,
in contrast with the composition of example 11, no bubbling or foaming takes place.
the solids content of this composition is 98%, i.e. it contains 2% solvent, which not only makes it compliant with the new regulations relating to the solvent content, but also classifies it in the USA as a solvent-free product.

1-15. (canceled)

16. A diluent comprising:
a polyisocyanate or a mixture of polyisocyanates having a number of isocyanate functions strictly greater than 1 and less than or equal to 3.1;
a bis-oxazolidine and optionally a mono-oxazolidine;
a catalyst;
the amounts of bis-oxazolidine, and optionally of mono-oxazolidine, and of polyisocyanate having a number of isocyanate functions strictly greater than 1 and less than or equal to 3.1 being such that the molar ratio between the —NH functions of the bis-oxazolidine, and optionally of the mono-oxazolidine, and the NCO functions is from 0.3 to 0.75; the —NH functions of the bis-oxazolidine, and optionally of the mono-oxazolidine, being the —NH functions derived from the amine functions formed after opening of the oxazolidine ring.

17. The diluent according to claim 16, wherein said diluent does not comprise any solvent and/or any exogenous plasticizer.

18. The diluent according to claim 16, wherein the amount of catalyst is between 10% and 70%, by weight relative to the weight of the bis-oxazolidine.

19. The diluent according to claim 16, comprising:
an amount of polyisocyanate having a number of isocyanate functions strictly greater than 1 and less than or equal to 3.1, such that the number of NCO functions is equivalent to that of 100 parts by weight of diphenylmethane diisocyanate MDI (CAS No. 26447-40-5);
40 to 100 parts by weight of bis-oxazolidine and optionally of mono-oxazolidine;
30 to 50 parts by weight of catalyst.

20. The diluent according to claim 16, wherein the bis-oxazolidine comprises a carbonate group between the two oxazolidine rings and corresponds to the following general formula: 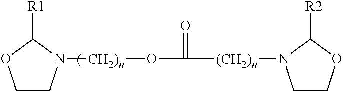
wherein n is an integer equal to 1, 2, 3 or 4; and
wherein R1 and R2 are, independently, a hydrogen or a linear or branched alkyl comprising 1 to 4 carbon atoms.

21. The diluent according to claim 16, wherein the bis-oxazolidine has a viscosity of less than 80 mPa·s at 20° C.

22. The diluent according to claim 16, wherein the bis-oxazolidine corresponds to the following general formula:

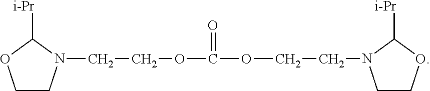

23. The diluent according to claim 16, wherein the catalyst is chosen from the group consisting of organic acid anhydrides; long-chain fatty acids; organometallic salts; and mixtures thereof.

24. The diluent according to claim 16, wherein the polyisocyanate having a number of isocyanate functions strictly greater than 1 and less than or equal to 3.1 is chosen from the group consisting of an aromatic, aliphatic or cycloaliphatic polyisocyanate, and mixtures thereof.

25. The diluent according to claim 16, wherein the polyisocyanate has a number of isocyanate functions strictly greater than 1.5 and less than or equal to 2.2 and is a polyisocyanate masked with a monoalcohol formed by reaction between a monoalcohol of formula B—OH and a polyisocyanate of formula A-NCO, wherein B represents an alkyl, and A represents a group comprising a number of isocyanate functions between 1.5 and 2.2, as defined in patent application PCT/FR2012/052372.

26. The diluent according to claim 16, wherein the polyisocyanate having a number of isocyanate functions strictly greater than 1 and less than or equal to 3.1 is a polymerizable plasticizer containing a hydrocarbon chain, only one end of which bears more than one isocyanate function, said polymerizable plasticizer being the reaction product of:
an alcohol type compound containing a hydrocarbon chain comprising and/or being substituted with an aromatic ring and/or an aliphatic ring and/or said hydrocarbon chain of the alcohol type compound is substituted with at least two hydrocarbon chains which may comprise an unsaturation and wherein said alcohol type compound has an —OH number between 0.8% and 2.5%; with
a polyisocyanate comprising 2.1 to 3.2 isocyanate functions.

27. The diluent according to claim 16, wherein the polyisocyanate having a number of isocyanate functions strictly greater than 1 and less than or equal to 3.1 is a prepolymer resulting from the reaction between a polyol or a mixture of polyols containing a number of OH functions between 1.5 and 3 and a polyisocyanate or a mixture of polyisocyanates containing a number of NCO functions between 1.6 and 3, in a ratio such that the number of NCO functions of the polyisocyanate or of the polyisocyanate mixture relative to the number of OH functions of the polyol or mixture of polyols is from 1.5 to 2.5 approximately.

28. A polyurethane resin composition comprising:
from 10% to 70% by weight of diluent according to claim 16 relative to the weight of the composition;
from 30% to 90% by weight of a prepolymer relative to the weight of the composition;
from 0 to 20% by weight of a filler relative to the weight of the composition;
from 0 to 10% by weight of solvent relative to the weight of the composition;
from 0 to 50% by weight of an exogenous plasticizer or of a polymerizable plasticizer relative to the weight of the composition;
from 0 to 50% by weight of a bituminous mixture relative to the weight of the composition,
said composition comprising between 0.5% and 5% by weight of catalyst relative to the weight of the composition, said catalyst originating from the introduction of the diluent according to claim 16 into said composition, with the exclusion of any other source of catalyst.

29. A method for the preparation of a polyurethane resin composition comprising introducing the diluent according to claim 16 in said polyurethane resin composition.

30. A method for the preparation of a coating which does not have any surface defects and which is strong enough for exterior use, unprotected and trafficable, which has a water uptake of less than 8% after 28 days of immersion in water at 20° C. comprising applying the composition according to claim 28 on a surface.
